(19) United States
(12) Patent Application Publication
(10) Pub. No.: US 2024/0201450 A1
(43) Pub. Date: Jun. 20, 2024

(54) OPTICAL CONNECTOR CLEANING TOOL

(71) Applicant: NIPPON TELEGRAPH AND TELEPHONE CORPORATION, Tokyo (JP)

(72) Inventors: Yoshiteru ABE, Musashino-shi, Tokyo (JP); Ryo KOYAMA, Musashino-shi, Tokyo (JP); Chisato FUKAI, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/286,196

(22) PCT Filed: May 17, 2021
(86) PCT No.: PCT/JP2021/018551

§ 371 Date: Oct. 9, 2023

(51) Int. Cl. G02B 6/38; B08B 1/14; B08B 1/30; B08B 11/02

(52) U.S. Cl. CPC G02B 6/3866; B08B 1/143; B08B 1/30; B08B 11/02; B08B 2240/02

(57) ABSTRACT

An object of the present disclosure is to provide an optical connector cleaning tool capable of cleaning a ferrule end surface with an appropriate force regardless of an operator.

The present disclosure is an optical connector cleaning tool including a housing that stores a cleaning sheet, an opening portion through which a part of the cleaning sheet is exposed from the housing, a slide mechanism that causes the cleaning sheet exposed to the opening portion to slide, a cleaning sheet support portion that is fixed to the housing and supports the cleaning sheet toward the opening portion, a plug holding unit that holds an optical connector plug having a ferrule disposed at a distal end thereof at the opening portion, and a pressing portion that applies a pressing force between the cleaning sheet support portion and the plug holding unit.

### TECHNICAL FIELD

The present disclosure relates to an optical connector cleaning tool for cleaning a ferrule end surface of an optical connector plug.

### BACKGROUND ART

In an optical communication network, an optical connector that connects optical fibers is used. As a single core optical connector for connecting a single core optical fiber, an SC connector using a cylindrical ferrule, an LC connector, or the like is used, and a multi-fiber push on (MPO) connector is used as a multi-core optical connector for connecting a multi-core fiber in an optical fiber cable. In these optical connectors, after an optical fiber is inserted into an optical fiber hole of a ferrule and bonded and fixed, an end surface of the ferrule is polished and incorporated in an optical connector plug. In the optical connector plug, the ferrule is pressed by a spring installed at the rear end of the ferrule. When the optical connector plugs are inserted from both sides of the optical connector adapter, the end surfaces of the optical fibers held by the ferrules are in contact with each other without any gap due to the pressing force of the spring, thereby realizing optical fiber connection with low loss and high reflection attenuation. When an optical fiber is connected in a state in which a foreign matter adheres between fiber end surfaces of the optical fiber inserted from both sides of the optical connector adapter, deterioration of connection characteristics such as an increase in connection loss and an increase in reflection occurs, and as a result, transmission performance of an optical signal is deteriorated. Therefore, the ferrule end surface of the optical connector is cleaned before connection.

As a method for cleaning an optical connector, a cleaning tool (see, for example, Patent Literature 1) for cleaning an end surface of a ferrule of an optical connector plug using a cleaning sheet is known. In addition, a cleaning tool (see, for example, Patent Literature 2) for cleaning an end surface and a side surface of a ferrule of an optical connector plug by disposing a cleaning cloth in a recess into which the ferrule of the optical connector plug is inserted is known. In addition, a cleaning tool (see, for example, Patent Literature 3) for cleaning an end surface of an optical connector plug and an end surface of a ferrule of an optical connector plug incorporated in an optical connector adapter using a cleaning thread is known.

In the conventional optical connectors, an optical fiber end surface is exposed at a ferrule end surface. However an optical connector in which a film is formed by curing a refractive index matching material, which is an ultraviolet curable resin having a refractive index matched with that of quartz glass, at the ferrule end surface has been studied. In this optical connector, the end surface of the optical fiber is covered with a film of a refractive index matching material at the end surface of the ferrule.

### CITATION LIST

### Patent Literature

Patent Literature 1: JP 2001-246343 A (NTT-AT)
Patent Literature 2: JP 2005-258473 A (NTT-AT)
Patent Literature 3: Japanese Patent No. 5049350 (NTT-AT)

### SUMMARY OF INVENTION

### Technical Problem

In the conventional optical connector cleaning tools as disclosed in Patent Literature 1 to Patent Literature 3, a cleaning worker presses an end surface of a ferrule of an optical connector plug against a cleaning portion of the cleaning tool to clean the end surface of the ferrule. At this time, since it is not configured to control the force of pressing the ferrule end face against the cleaning portion, and the pressing force changes depending on the force of the cleaning operator, there is a problem that the ferrule end surface cannot be cleaned with a constant force without depending on the cleaning worker. Further, in these conventional optical connector cleaning tools, when cleaning an optical connector plug in which a refractive index matching material is cured on an end surface of a ferrule, there is a problem that a cleaning worker presses the end surface of the ferrule against a cleaning portion with a strong force, so that a film of the refractive index matching material is peeled off from the end surface of the ferrule.

Therefore, the present disclosure has been proposed in view of the above circumstances, and an object of the present disclosure is to provide an optical connector cleaning tool capable of cleaning a ferrule end surface with an appropriate force regardless of an operator.

### Solution to Problem

In order to achieve the above object, the present disclosure provides an optical connector cleaning tool that cleans a ferrule end surface of an optical connector plug by sliding a cleaning sheet while bringing the cleaning sheet into contact with the ferrule end surface of the optical connector plug, in which the optical connector cleaning tool includes a plug holding unit that holds the optical connector plug in an opening portion through which the cleaning sheet is exposed; and a pressing portion that applies a predetermined pressing force between the ferrule end surface and the cleaning sheet.

Specifically, the optical connector cleaning tool of the present disclosure includes a housing that stores a cleaning sheet, an opening portion through which a part of the cleaning sheet is exposed from the housing, a slide mechanism that causes the cleaning sheet exposed to the opening portion to slide, a cleaning sheet support portion that is fixed to the housing and supports the cleaning sheet toward the opening portion, a plug holding unit that holds an optical connector plug having a ferrule disposed at a distal end thereof at the opening portion, and a pressing portion that applies a pressing force between the cleaning sheet support portion and the plug holding unit.

### Advantageous Effects of Invention

According to the optical connector cleaning tool of the present disclosure, since the optical connector plug is fixed to the opening portion, and the cleaning sheet can be slid while the cleaning sheet is pressed against the ferrule end surface, it is not necessary for a cleaning worker to press the optical connector plug against the cleaning sheet. Therefore, the present disclosure can provide a cleaning tool for an optical connector capable of cleaning a ferrule end surface with an appropriate force regardless of an operator.

### BRIEF DESCRIPTION OF DRAWINGS

FIG. 1 is a schematic cross-sectional view illustrating an example of an embodiment of an optical connector cleaning tool of the present disclosure.

FIG. 2 is a side view in which an opening portion is disposed in the optical connector cleaning tool.

FIG. 3 illustrates a configuration example of an MPO connector plug.

FIG. 4 is a schematic view illustrating an example of an optical connector plug cleaning method using the optical connector cleaning tool of the present disclosure.

FIG. 5 is a schematic cross-sectional view illustrating an example of the embodiment of the optical connector cleaning tool of the present disclosure.

FIG. 6 is a schematic view illustrating an example of the optical connector plug cleaning method using the optical connector cleaning tool of the present disclosure.

FIG. 7 is a schematic cross-sectional view illustrating an example of the embodiment of the optical connector cleaning tool of the present disclosure.

### DESCRIPTION OF EMBODIMENTS

Hereinafter, embodiments of the present disclosure will be described in detail with reference to the drawings. The present disclosure is not limited to the embodiments described below. These embodiments are merely an example, and the present disclosure can be carried out in forms with various modifications and improvements on the basis of knowledge of those skilled in the art. Note that components having the same reference numerals in the present specification and the drawings indicate the same components.

### First Embodiment

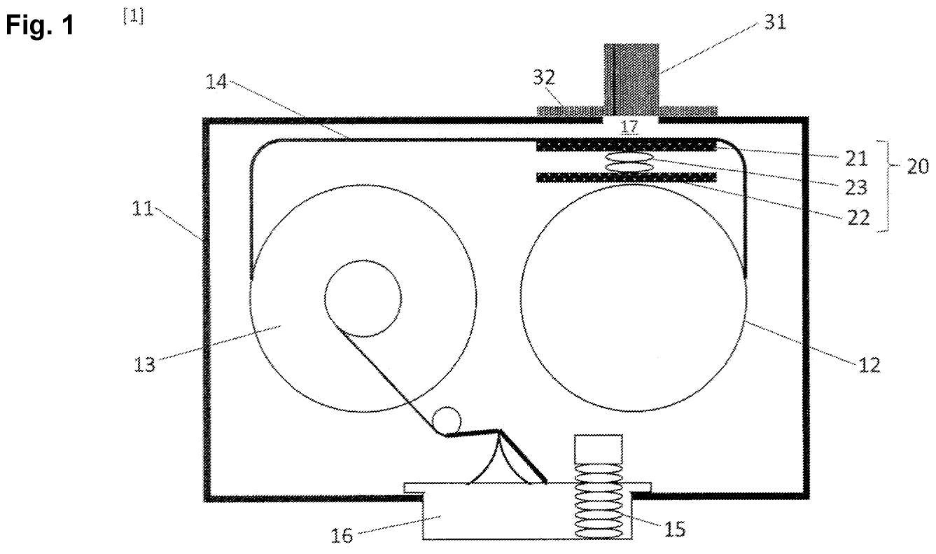

An embodiment of an optical connector cleaning tool and an optical connector cleaning method according to the present disclosure will be described with reference to the drawings. FIG. 1 is a schematic view illustrating an example of the embodiment of the optical connector cleaning tool of the present disclosure. In the optical connector cleaning tool of the present disclosure, a cleaning sheet 14 is stored in a housing 11, and a part of the cleaning sheet 14 is exposed from an opening portion 17. Specifically, in the optical connector cleaning tool of the present disclosure, a tape-shaped cleaning sheet 14, an opening portion 17 for exposing the cleaning sheet 14, a cleaning sheet support portion 20 for supporting a part of the cleaning sheet 14 in the longitudinal direction by the opening portion 17, and a slide mechanism for sliding the cleaning sheet 14 exposed to the opening portion 17 are incorporated in the housing 11. In the present embodiment, as the slide mechanism, a feeding reel 12, a winding reel 13, and a spring 15 and a reel lever 16 for moving the reels 12 and 13 in conjunction with each other are incorporated in the housing 11. In the optical connector cleaning tool of the present disclosure, a plug holding unit 31 is attached to the outside of the housing 11 of the opening portion 17. In FIG. 1, the inside of the housing 11 is illustrated in a cross-sectional view, and the plug holding unit 31 is illustrated in a side view.

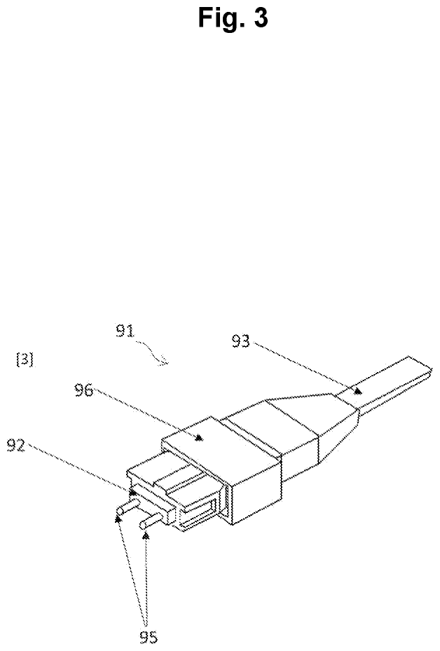

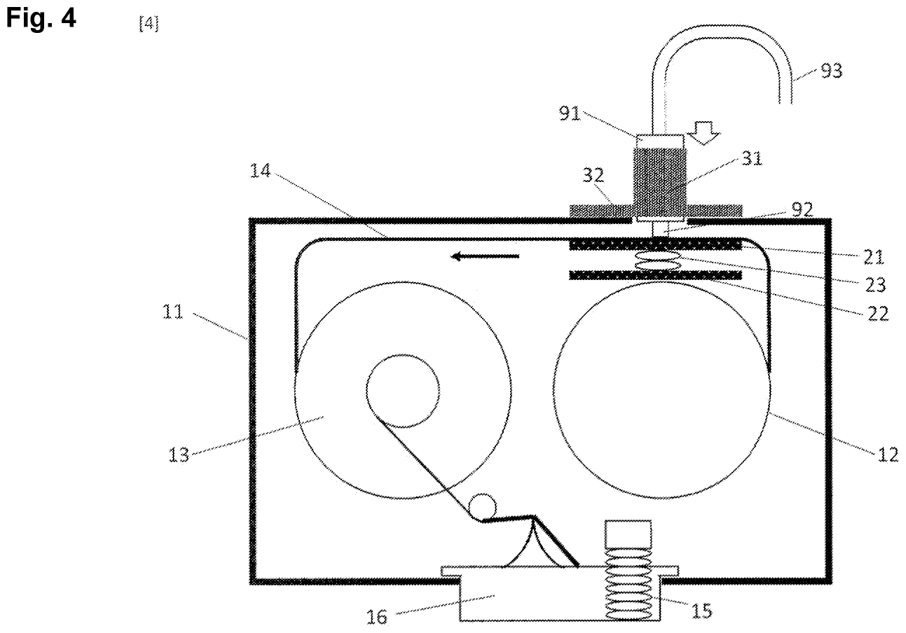

The cleaning sheet 14 is drawn out from the feeding reel 12, passes through the opening portion 17, and has an end portion fixed to the winding reel 13. The cleaning sheet support portion 20 is fixed to the housing 11, and supports the cleaning sheet 14, which is fed from the feeding reel 12 and is not wound around the winding reel 13, toward the opening portion 17. The present disclosure includes a pressing portion that applies a pressing force between the cleaning sheet support portion 20 and the plug holding unit 31, and applies the pressing force to the distal end side of an MT ferrule (reference numeral 92 illustrated in FIGS. 3 and 4). In the present embodiment, an example in which the cleaning sheet support portion 20 includes a spring 23 functioning as a pressing portion will be described.

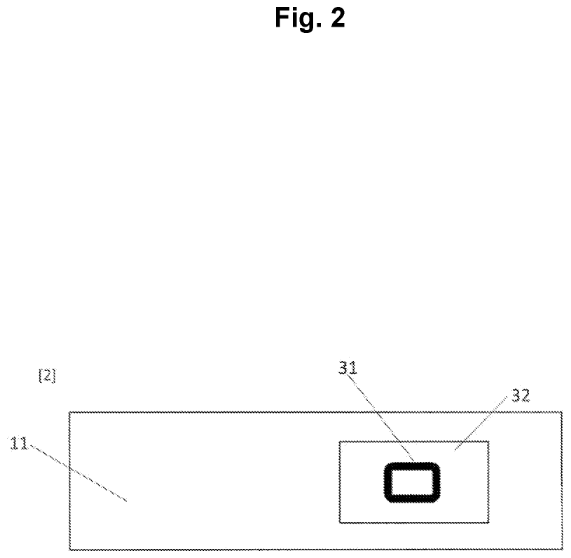

FIG. 2 is a side view of the housing 11 in which the opening portion 17 is disposed. The plug holding unit 31 has a tubular shape, and an MPO connector plug (reference numeral 91 illustrated in FIGS. 3 and 4) is held inside the tube. The plug holding unit 31 is fixed to a wall surface fixing unit 32 perpendicular to the center axis of the tube of the plug holding unit 31. When the wall surface fixing unit 32 comes into contact with the side surface of the housing 11, the center axis of the MPO connector plug (reference numeral 91 illustrated in FIGS. 3 and 4) in the longitudinal direction is held perpendicular to the side surface of the housing 11.

FIG. 3 illustrates a configuration example of an MPO connector plug 91. In the MPO connector plug 91, an MT ferrule 92 is incorporated in a plug housing 96. The MT ferrule 92 has an optical fiber hole (not illustrated) for bonding and fixing a multicore optical fiber 93, and a guide pin 95 or two guide pin holes (not illustrated) for inserting or fixing the guide pin. When the MPO connector plug 91 is inserted from the opening portions at both ends of an MPO connector adapter (not illustrated), the guide pin 95 fixed to the MT ferrule 92 provided in one MPO connector plug 91 is inserted into a guide pin hole (not illustrated) provided in the other MPO connector plug 91, whereby the MT ferrules 92 provided in the two MPO connector plugs 91 are fitted to each other.

Here, in the plug housing 96 of the MPO connector plug 91, a spring (not illustrated) is provided at the rear end of the MT ferrule 92, and a force that pushes the MT ferrule 92 toward the distal end side of the MT ferrule 92 is always applied. In a case where the MPO connector plug 91 is inserted into the MPO connector adapter (not illustrated), the coupling between the MPO connector plug 91 and the MPO connector adapter is maintained by locking the locking piece of the MPO connector adapter to the locking portion of the plug housing 96.

FIG. 4 is a schematic view when the MPO connector plug 91 is inserted into the plug holding unit 31. The plug holding unit 31 has a structure obtained by dividing the MPO connector adapter from the center. Therefore, when the MPO connector plug 91 is inserted into the plug holding unit 31, a locking piece of the plug holding unit 31 is locked to the locking portion of the plug housing (reference numeral 96 illustrated in FIG. 3), whereby the MPO connector plug 91 can be fixed to the plug holding unit 31. Note that the MPO connector plug 91 in FIG. 4 is not limited to the MPO connector, and may be any optical connector for connecting the multicore optical fiber 93.

When the MPO connector plug 91 is fixed by the plug holding unit 31, the distal end surface of the MT ferrule 92 is in contact with the cleaning sheet 14. Below the cleaning sheet 14, a plate 21 with which the cleaning sheet 14 is in contact, a spring 23 that presses the plate 21 in the distal end direction of the MT ferrule 92 from below the plate 21, and a spring fixing unit 22 that supports one end of the spring 23 are provided.

Since the spring 23 acts as a force of pressing the cleaning sheet 14 against the distal end surface of the MT ferrule 92, it is necessary to appropriately set a spring force. In a case of cleaning the distal end surface of the MPO connector plug 91 in which the refractive index matching material is cured on the distal end surface of the MT ferrule 92, the spring 23 is used such that the force of pressing the cleaning sheet 14 against the distal end surface of the MT ferrule 92 is less than the force of peeling the refractive index matching material. The force for peeling off the refractive index matching material depends on the combination of the refractive index matching material and the distal end surface of the MT ferrule 92. For example, in a case where the adhesive force between the refractive index matching material and the distal end surface of the MT ferrule 92 is equal to or greater than 0.6 N, and the refractive index matching material is not peeled off even when the cleaning sheet 14 is slid in a state where the cleaning sheet 14 is in contact with the refractive index matching material with a force of about 0.5 N, the force with which the spring 23 presses the cleaning sheet 14 against the distal end surface of the MT ferrule 92 is set to less than 0.6 N, for example, 0.5 N.

A cleaning procedure and movement of a cleaning sheet in the optical connector cleaning tool of the present disclosure will be described with reference to FIG. 4. First, the MPO connector plug 91 to be cleaned is inserted into the plug holding unit 31 to fix the MPO connector plug 91. The reel lever 16 and the winding reel 13 are connected to each other, and when the reel lever 16 is pushed from the lower portion, the winding reel 13 rotates counterclockwise, the cleaning sheet 14 is pulled out from the feeding reel 12, and the cleaning sheet 14 in contact with the distal end surface of the MT ferrule 92 moves from right to left to clean the distal end surface of the MT ferrule 92. The MPO connector plug 91 is pulled out from the plug holding unit 31, and the reel lever 16 is pushed again to expose the clean cleaning sheet 14 to the opening portion 17, thereby preparing for the next cleaning.

### Second Embodiment

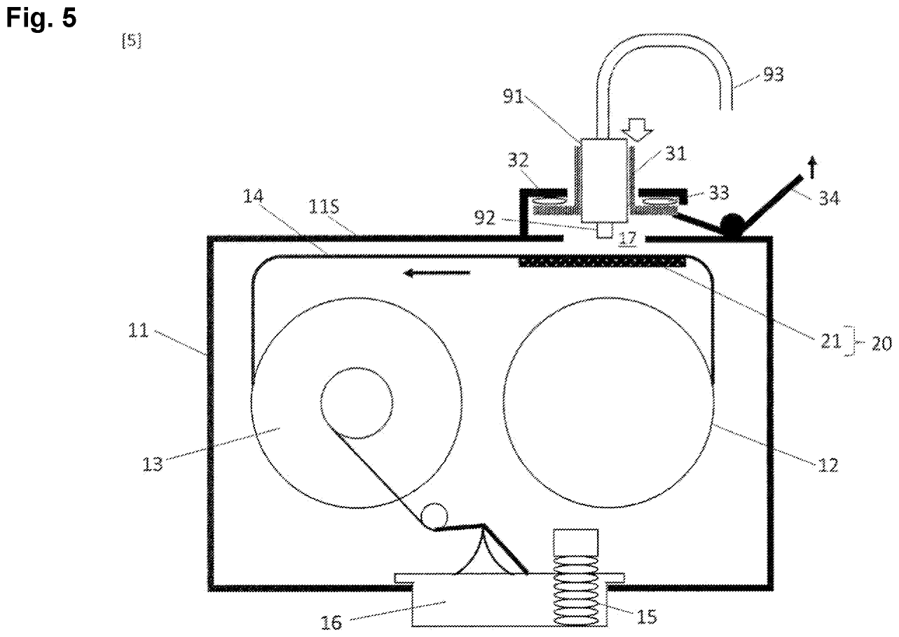

FIG. 5 is a schematic view illustrating an example of the embodiment of the optical connector cleaning tool of the present disclosure. In the present embodiment, instead of a spring fixing unit 22 and the spring 23 in the first embodiment, a spring 33 functioning as a pressing portion and a plug holding unit operation lever 34 are provided between the housing 11 and the wall surface fixing unit 32.

In the optical connector cleaning tool of the present embodiment, the cleaning sheet 14, the plate 21 that supports the cleaning sheet 14, the opening portion 17 that exposes the cleaning sheet 14, the feeding reel 12, the winding reel 13, and the spring 15 and the reel lever 16 for moving these reels 12 and 13 in conjunction with each other are incorporated in the housing 11. In the optical connector cleaning tool of the present embodiment, the plug holding unit 31 is attached to the outside of the housing 11 of the opening portion 17 via the plug holding unit operation lever 34. The cleaning sheet 14 is drawn out from the feeding reel 12, passes through the opening portion 17, and has an end portion fixed to the winding reel 13.

Further, in FIG. 5, the MPO connector plug 91 is inserted into the plug holding unit 31. The plug holding unit 31 is the same as that of the first embodiment. However, in FIG. 5, the plug holding unit 31 is not directly fixed to the housing 11, but is fixed to the housing 11 via the spring 33. Specifically, the wall surface fixing unit 32 is fixed to a side surface 11S of the housing 11, and the plug holding unit 31 and the wall surface fixing unit 32 are connected by the spring 33. As a result, one end is fixed to the wall surface fixing unit 32, another end is fixed to the plug holding unit 31, and the plug holding unit 31 is pressed toward the opening portion 17 with a constant force.

Here, the wall surface fixing unit 32 is arranged in parallel to the side surface 11S of the housing 11 so that the central axis of the plug holding unit 31 is kept perpendicular to the side surface 11S of the housing 11, and the spring 33 is evenly arranged around the plug holding unit 31. The plug holding unit 31 is coupled to the plug holding unit operation lever 34 that pushes down the plug holding unit 31, and the plug holding unit 31 can be lowered in the direction of the opening portion 17 of the housing 11 by raising the plug holding unit operation lever 34.

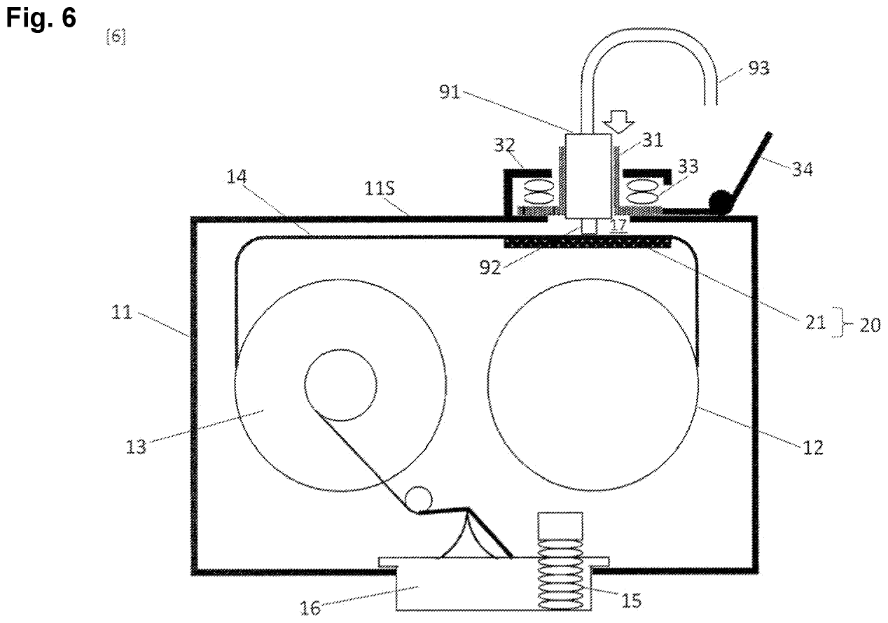

FIG. 6 illustrates a state when the plug holding unit operation lever 34 is raised and the plug holding unit 31 is pushed down in the direction of the opening portion 17 of the housing 11. A lever fixing unit (not illustrated) for fixing the plug holding unit operation lever 34 in a lowered state is attached to the housing 11, and the plug holding unit operation lever 34 is raised by releasing the lever fixing unit, and the plug holding unit 31 can be brought into a state of being pushed down in the direction of the opening portion 17 of the housing 11.

At this time, the distal end surface of the MT ferrule 92 is in contact with the cleaning sheet 14, and similarly to the first embodiment, the pressing force to the cleaning sheet 14 is adjusted by the spring 33 under the plug holding unit 31 to be about 0.5 N. Even if the cleaning sheet 14 is slid in a state where the cleaning sheet 14 is in contact with the refractive index matching material with a force of about 0.5 N, the refractive index matching material is not peeled off. After the distal end surface is cleaned by the cleaning sheet 14, the plug holding unit operation lever 34 is pushed down and fixed by the lever fixing unit, whereby the plug holding unit 31 is lifted up.

### Third Embodiment

There are two types of MPO connector plugs 91 of a plug having a guide pin fixed to the MT ferrule 92 and a plug having no guide pin. In the MPO connector plug 91 having the guide pin, the distal end of the guide pin protrudes from the distal end surface of the MT ferrule 92 to be cleaned. Therefore, when the distal end surface of the MT ferrule 92 of the MPO connector plug 91 having the guide pin is cleaned, the cleaning sheet 14 needs to be configured not to interfere with the guide pin.

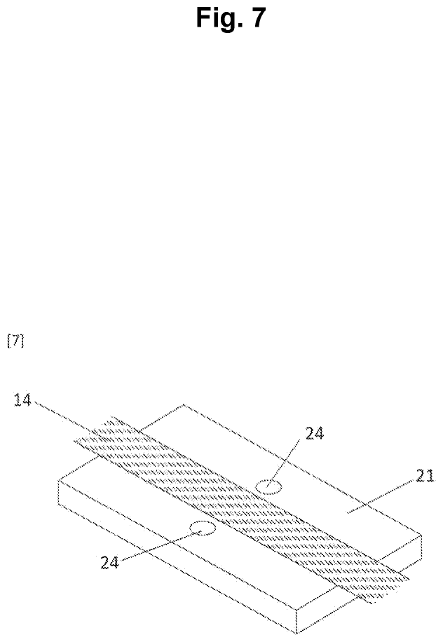

Therefore, in the above-described embodiment, the cleaning sheet 14 and the plate 21 have the configuration illustrated in FIG. 7. The plate 21 includes two pin insertion holes 24 into which guide pins are inserted. The inner diameter of the pin insertion hole 24 is larger than the diameter of the guide pin. The pin insertion hole 24 is disposed with a region where the cleaning sheet 14 is arranged interposed therebetween. The interval between the two pin insertion holes 24 is equal to the interval between the two guide pin holes of the ferrule. The width of the cleaning sheet 14 to be slid while being in contact with the distal end surface of the MT ferrule 92 is narrower than the interval between the guide pins fixed to the MT ferrule 92, so that the cleaning sheet 14 can be slid without interfering with the guide pins.

As described above, the optical connector cleaning tool according to the present embodiment includes the cleaning sheet 14 that comes into contact with the distal end surface of the MT ferrule 92 of the optical connector plug to clean the distal end surface, the cleaning sheet support portion 20 that supports the cleaning sheet 14, the opening portion 17 that exposes the cleaning sheet 14, the feeding reel 12, the winding reel 13, and the housing 11 that stores the spring 15 and the reel lever 16 for moving the two reels 12 and 13 in conjunction with each other, in which the plug holding unit 31 that holds the optical connector plug is fixed to the housing 11 at the upper portion of the opening portion 17.

In the present disclosure, the cleaning sheet 14 can be slid to clean the distal end surface of the MT ferrule 92 in a state where the cleaning sheet 14 is pressed against the distal end surface of the MT ferrule 92 with a constant force defined by the spring 23 or 33. Therefore, in the present disclosure, it is not necessary for the cleaning worker to press the MPO connector plug 91 against the cleaning sheet 14, and it is possible to prevent peeling of the film of the refractive index matching material due to the cleaning worker pressing the end surface of the ferrule against the cleaning portion with a strong force.

Here, as the springs 23 and 33, in addition to the compression coil spring, any elastic body such as a resin that can press the cleaning sheet 14 against the distal end surface of the MT ferrule 92 with an appropriate force can be used.

In the above-described embodiment, an example in which the ferrule is an MT ferrule has been described, but the ferrule of the present disclosure can be applied to any ferrule capable of holding one or more optical fibers. Therefore, the present disclosure can be applied to any optical connector that connects one or more optical fibers.

Furthermore, in the above-described embodiment, an example has been described in which the opening portion 17 is provided on the surface facing the reel lever 16, but the position where the opening portion 17 is provided is arbitrary, and for example, these may be arranged on the same surface. Further, the slide mechanism is not limited to the configuration using the feeding reel 12, the winding reel 13, the spring 15, and the reel lever 16, and any configuration capable of sliding the cleaning sheet 14 exposed to the opening portion 17 can be adopted.

### INDUSTRIAL APPLICABILITY

According to the optical connector cleaning tool according to the present disclosure, it is possible to eliminate unevenness of a cleaning degree due to a force level of a worker in cleaning work of an end surface of a ferrule of an optical connector plug, and it is possible to control a force of pressing a cleaning sheet against the end surface of the ferrule. Therefore, it is also possible to appropriately clean an optical connector in which a refractive index matching material is cured on the end surface of the ferrule.

### REFERENCE SIGNS LIST

11 Housing
12 Feeding reel
13 Winding reel
14 Cleaning sheet
15 Spring
16 Reel lever
17 Opening portion
20 Cleaning sheet support portion
21 Plate
22 Spring fixing unit
23 Spring
31 Plug holding unit
32 Wall surface fixing unit
33 Spring
34 Plug holding unit operation lever
91 MPO connector plug
92 MT ferrule
93 Optical fiber
95 Guide pin hole
96 Plug housing

1. An optical connector cleaning tool comprising:
a housing that stores a cleaning sheet;
an opening portion through which a part of the cleaning sheet is exposed from the housing;
a slide mechanism that causes the cleaning sheet exposed to the opening portion to slide;
a cleaning sheet support portion that is fixed to the housing and supports the cleaning sheet toward the opening portion;
a plug holding unit that holds an optical connector plug having a ferrule disposed at a distal end thereof at the opening portion; and
a pressing portion that applies a pressing force between the cleaning sheet support portion and the plug holding unit.

2. The optical connector cleaning tool according to claim 1, wherein the cleaning sheet support portion includes:
a plate that supports the cleaning sheet,
an elastic body that presses the plate against the opening portion with a constant force, and
a fixing unit that fixes one end of the elastic body to the housing, and
the elastic body functions as the pressing portion that presses the cleaning sheet supported by the plate against the distal end of the ferrule.

3. The optical connector cleaning tool according to claim 1, further comprising:
an elastic body having one end fixed to the housing and another end fixed to the plug holding unit and pressing the plug holding unit against the opening portion with a constant force, wherein
the elastic body functions as the pressing portion that presses the distal end of the ferrule held by the plug holding unit against the cleaning sheet.

4. The optical connector cleaning tool according to claim 1, wherein the cleaning sheet support portion includes two holes disposed to sandwich a region where the cleaning sheet is disposed,
an inner diameter of each of the two holes is larger than a diameter of a guide pin of the ferrule, and
an interval between the two holes is equal to an interval between two guide pin holes of the ferrule.

5. The optical connector cleaning tool according to claim 1, wherein a width of the cleaning sheet is narrower than an interval between two guide pins of the ferrule.

6. The optical connector cleaning tool according to claim 1, wherein the slide mechanism includes
a feeding reel that delivers the cleaning sheet,
a winding reel that winds up the cleaning sheet fed from the feeding reel, and
a lever that causes the winding reel to wind up the cleaning sheet.

7. The optical connector cleaning tool according to claim 1, wherein the plug holding unit includes a locking piece that locks with a locking portion provided in a plug housing incorporating the ferrule, and
the locking piece is locked with a locking portion provided in the plug housing to hold the optical connector plug.
